(19) United States
(12) Patent Application Publication
(10) Pub. No.: US 2026/0101083 A1
(43) Pub. Date: Apr. 9, 2026

(54) PLAYBACK METHOD, APPARATUS AND ELECTRONIC DEVICE

(71) Applicant: Beijing Zitiao Network Technology Co., Ltd., Beijing (CN)

(72) Inventors: Zeqian ZHANG, Beijing (CN); Yachen LI, Beijing (CN); Di WU, Beijing (CN)

(21) Appl. No.: 19/114,421

(22) PCT Filed: Sep. 22, 2023
(86) PCT No.: PCT/CN2023/120816

§ 371 Date: Mar. 21, 2025

(30) Foreign Application Priority Data
Sep. 22, 2022 (CN) 202211161091.8

(51) Int. Cl. H04N 21/431; H04N 21/472

(52) U.S. Cl. CPC H04N 21/431; H04N 21/47217

(57) ABSTRACT

The present disclosure relates to a playback method, apparatus and electronic device. An embodiment of the method comprising: in response to a video as a first type of video, displaying prompt information of a first display state on a video playback interface, wherein the first type of video is provided with a playback restriction, and the prompt information is used to prompt the removal of the playback restriction; and in response to a satisfaction of a preset condition, transforming the prompt information from the first display state to a second display state on the video playback interface.

### CROSS-REFERENCE TO RELATED APPLICATIONS

The present application claims the priority of the Chinese patent application No. 202211161091.8, filed on Sep. 22, 2022, “Playback Method, Apparatus and Electronic Device”, which is incorporated herein by reference in its entirety.

### TECHNICAL FIELD

The present disclosure relates to the field of computer technology, in particular to a playback method, apparatus and electronic device.

### BACKGROUND

With the development of computers, users can use electronic devices to achieve various functions. For example, users can watch various types of videos through electronic devices.

In some scenarios, the streaming platform may set playback restrictions on the video. In other words, a streaming platform may restrict some users to watching a full video, perhaps by limiting them to certain parts of the video, or to certain periods of time, or to watching a video for no more than a preset amount of time.

### SUMMARY

The disclosure section is provided to present the ideas in brief form, which are described in detail in a later section on how to implement them. This disclosure section is not intended to identify the key or necessary features of the technical solution claiming protection, nor is it intended to limit the scope of the technical solution claiming protection.

According to the first aspect, the embodiments of the present disclosure provide a playback method, comprising: in response to a video as a first type of video, displaying prompt information of a first display state on a video playback interface, wherein the first type of video is provided with a playback restriction, and the prompt information is used to prompt the removal of the playback restriction; and in response to a satisfaction of a preset condition, transforming the prompt information from the first display state to a second display state on the video playback interface.

According to the second aspect, the embodiments of the present disclosure provide a playback apparatus, including: displaying unit, configured to display prompt information of a first display state on a video playback interface in response to a video as a first type of video, wherein the first type of video is provided with a playback restriction, and the prompt information is used to prompt the removal of the playback restriction; and transforming unit, configured to transform the prompt information from the first display state to a second display state on the video playback interface in response to a satisfaction of a preset condition.

According to the third aspect, the embodiments of the present disclosure provide an electronic device comprising: one or more processors; and a storage apparatus configured to store one or more programs, wherein the one or more programs when executed by the one or more processors cause the one or more processors to implement the method according to the first aspect.

According to the fourth aspect, the embodiments of the present disclosure provide a non-transitory computer-readable medium on which a computer program is stored, wherein the computer program when executed by a processor causes the processor to implement the method in the first aspect.

### BRIEF DESCRIPTION OF THE DRAWINGS

The above and other features, advantages, and aspects of embodiments of the present disclosure become more apparent with reference to the following specific implementations and in conjunction with the accompanying drawings. Throughout the drawings, the same or similar reference numerals denote the same or similar elements. It should be understood that the accompanying drawings are schematic and that parts and elements are not necessarily drawn to scale.

FIG. 1 is a flow chart of embodiments of the playback method according to the present disclosure;

FIG. 2A and FIG. 2B are schematic diagrams of an application scenario according to the playback method of the present disclosure;

FIG. 3A and FIG. 3B are schematic drawings of an application scenario according to the playback method of the present disclosure;

FIG. 4A and FIG. 4B are schematic drawings of an application scenario according to the playback method of the present disclosure;

FIG. 5 is a structural diagram of embodiments of a playback apparatus according to the disclosure;

FIG. 6 is an exemplary system architecture to which the playback method of embodiments of the present disclosure can be applied;

FIG. 7 is a schematic diagram of the basic structure of the electronic device provided in accordance with the embodiment of the present disclosure.

### DETAILED DESCRIPTION OF EMBODIMENTS

Embodiments of the present disclosure are described in more detail with reference to the attached drawings below. Although certain embodiments of the disclosure are shown in the accompanying drawings, it should be understood that the disclosure may be implemented in various forms and should not be interpreted as limited to the embodiments set forth herein, but rather are provided for a more thorough and complete understanding of the disclosure. It should be understood that the drawings and embodiments of the disclosure are for illustrative purposes only and are not intended to limit the scope of protection of the disclosure.

It should be understood that the various steps described in the method embodiments of the present disclosure may be performed in a different sequence and/or in parallel. In addition, the method embodiments may include additional steps and/or omit the steps indicated in the execution. The scope of this disclosure is not limited in this respect.

The term “comprising” as used herein and its variants are open-ended to include, i.e., “comprising but not limited to”. The term “based” is “based at least in part”. The term “one embodiment” means “at least one embodiment”. The term “another embodiment” means “at least one additional embodiment”. And the term “some embodiments” means “at least some embodiments”. Relevant definitions of other terms are given in the description below.

It is important to note that references to “first”, “second” and other terms in this disclosure are used only to distinguish between different devices, modules or units and are not used to define the sequence or interdependence of functions performed by such devices, modules or units.

It is important to note that references to “one” and “many” in this disclosure are indicative rather than restrictive and should be understood by those skilled in the art to mean “one or more” unless otherwise expressly indicated in the context.

The names of messages or information to be exchanged between multiple devices in embodiments of this disclosure are used only for illustrative purposes and are not intended to limit the scope of such messages or information.

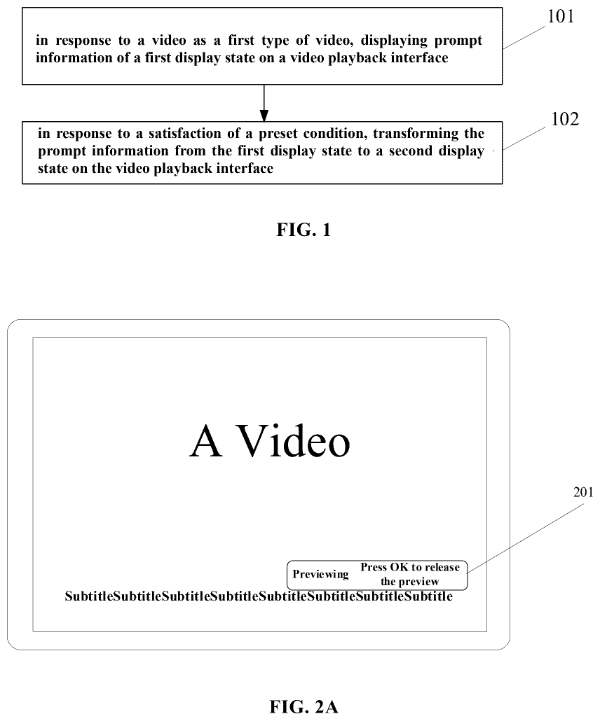

Please refer to FIG. 1, which shows the flow of embodiments according to the playback method of the present disclosure. The playback method, shown in FIG. 1, consists of the following steps:

Step 101: If the video is of the first type, the prompt information of a first display state is displayed on a video playback interface.

In this embodiment, the executing subject of the playback method (e.g., the server and/or the terminal device) may respond to the video being the first type of video and display the prompt information of the first display state on the video playback interface.

In this embodiment, the first type of video is provided with a playback restriction.

In this embodiment, the above prompt information may be used to prompt the removal of the playback restriction. Removing the playback restriction may include obtaining permission to view the full video.

In some embodiments, a prompt information may be used to prompt the execution of an interactive operation to remove the playback restriction. The interaction may be a predefined interaction.

For example, the predefined interaction may include clicking the confirm key (also known as the OK key) on the remote control, and following the instructions after clicking the confirm key to complete the operation. The above confirmation key and performing the above subsequent operations can be understood as performing the interactive operations.

Step 102: the prompt information is transformed from the first display state to the second display state on the video playback interface in response to the satisfaction of a preset condition.

In the present embodiment, the executive subject can transform the prompt information from the first display state to the second display state on the video playback interface in response to the satisfaction of the preset condition.

The preset condition herein can be set according to the actual application scenario, and are not limited. As an example, the preset condition can include the prompt information of the first display state displaying for more than 10 seconds.

It should be noted that the playback method provided by the embodiments herein, when playing the first type of video, the prompt information will be transformed from the first display state to the second display state in response to the satisfaction of the preset condition, thus enriching the display and interaction mode of the prompt information, facilitating users to obtain more video information and improving user experience. The prompt information can be displayed in different display states. In order to realize the way of reminding the removal of the playback restriction.

In some embodiments, the display area of the prompt information of the second display state is smaller than that of the first display state.

It should be noted that the display area of the second display state in the video playback interface is smaller than the display area of the first display state in the video playback interface. While continuing to prompt the user to facilitate the user to remove the playback restriction as soon as possible, the occlusion of the video played in the video playback interface can be reduced, that is, the user can not only watch the full video screen as much as possible, but also operate according to the prompts of the prompt information to remove the playback restrictions.

In some embodiments, the method may also comprise displaying a resource transfer interface in response to a trigger operation for the prompt information of the first display state or the prompt information of the second display state; and in response to completing a resource transfer operation through the resource transfer interface, removing the playback restriction to play the video in its entirety.

The resource transfer interface herein can be used to perform resource transfer operation. As an example, resource transfer operation can include transferring resources from the first account to the second account. The resource transfer interface displays a resource that has to be transferred to remove the playback restriction, that is, to watch the full video, and the resource can be a virtual resource, such as a credit voucher, etc.

Here, in response to the completion of the resource transfer operation, the playback restriction can be removed.

It should be noted that in the resource transfer scenario, the prompt information of different display states can be used to display, which can not only prompt users to transfer resources, but also ensure that users can watch the video as completely as possible.

In some embodiments, the prompt information of the first display state comprises video type prompt information and interactive operation prompt information.

In some embodiments, transforming the prompt information from the first display state to the second display state comprises: stopping displaying the video type prompt information, and retaining displaying the interactive operation prompt information.

Here, the video type prompt information may be used to indicate that the video is the first type of video. That is, when the user is informed that the video is the first type of video, the user can understand that the video has playback restrictions. As an example, the video type prompt information could include the following characters: Previewing. As an example, the video type prompt information could include the following characters: Previewing a paid video.

Here, the interactive operation prompt information can be used to indicate how the interactivity is performed and to remove playback restrictions when performing the interactivity. As an example, the interactive operation prompt information could include the following characters: “Press OK to release the preview”. As an example, the interactive operation prompt information could include the following characters: “Press OK to buy”. It should be noted that the method can be performed by the client on the TV, the TV side can be controlled by a remote control, the remote control has the OK key, accordingly, the OK key can be pressed to release the preview. As an example, on the mobile terminal, an interactive operation prompt information may indicate a click action on the prompt information or an interactive control on the prompt information.

It should be noted that the video type prompt information can explain to the user the reason why the video is provided with a playback restriction, and when the reason is displayed for a period of time, the user's need to know the reason is reduced. Interactive operation prompt information can remind the user to meet the user's needs on the way to remove the playback restriction. Therefore, by stopping the display of video type prompt information and retaining the display of interactive operation prompt information, the display area of the first prompt information can be reduced without affecting the satisfaction of users' needs, and the area of users' viewing of the video picture can be improved.

In some embodiments, the prompt information is transformed from the first display state to the second display state comprises but is not limited to at least one of the following: moving the prompt information from a first display area to a second display area; scaling the prompt information from a first display style to a second display style; transforming the prompt information from a first display content to a second display content.

As an example, the first display area can be an area that has a larger impact on the main content of the video, and the second display area can be an area that has a smaller impact on the main content of the video. The prompt information is moved from the first display area to the second display area, which can reduce the impact on the video screen and improve the efficiency of users in obtaining video content.

As an example, the first display style can be a more prominent display style, and the second display style can be a less prominent display style. Thus, the user can be initially prompted with a more prominent style (the first display style prompt information) to ensure that the user is fully informed; The less prominent way (the second display style prompt information) can be used to prevent the user from recalling the prompt content, thus reducing the occlusion of the prompt information on the video screen.

In some embodiments, transforming the prompt information from the first display state to the second display state may comprise transforming the prompt information from the prominent display state to the non-prominent display state. The prominent display state may be a highlighted display state, and the non-prominent display state may be a non-highlighted display state. The second display state may also be closer to the boundary of the video playback interface than the first display state. The second display state may also be of a smaller display size/area than that of the first display state.

In some embodiments, a prompt sticker is displayed on the video playback interface, the prompt sticker displays the prompt information, and the prompt sticker also comprises interactive controls, such as a close control and a size adjustment control. The close control is triggered to stop displaying the prompt sticker, and the size adjustment control is triggered to adjust the prompt sticker size. In addition, the prompt sticker can also be long-pressed to display the close control and the size adjustment control on the border of the prompt sticker, where the close control is triggered to stop displaying the prompt sticker, and the size adjustment control is triggered to adjust the size of the prompt sticker.

The prompt sticker can also include multiple sub stickers, each sub sticker can also have a corresponding interactive control (close control, size adjustment control), or each sub sticker can be long-pressed to display the interactive control corresponding to each sub sticker on the border of the sub sticker (close control, size adjustment control), where the close control is triggered to stop displaying the prompt sticker, and the size adjustment control is triggered to adjust the size of the prompt sticker.

In some embodiments, the prompt sticker/information may be a prompt sticker/information added by the publisher of the video in the process of publishing the video. During the video publishing process, the playback restriction is set for the video and the prompt sticker/information of the playback restriction is added, thereby prompting the user to remove the playback restriction during the preview and then watch the full video.

In some embodiments, transforming the prompt information from the first display state to the second display state comprises: reducing the font size of the characters in the prompt information.

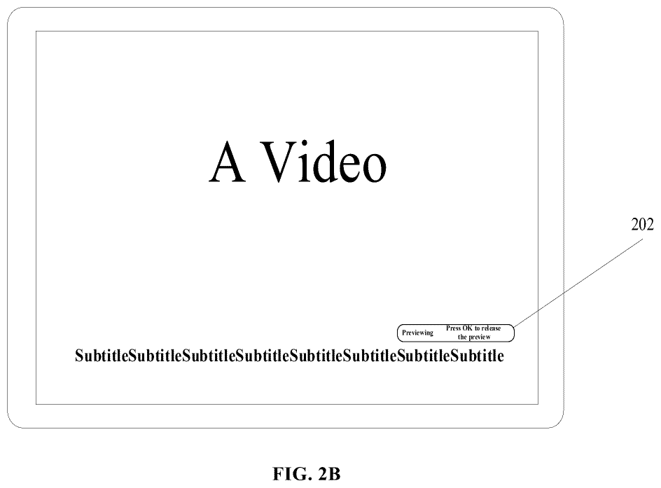

As an example, refer to FIGS. 2A and 2B, which show an exemplary implementation.

In FIGS. 2A and 2B, the video playback interface can play A Video. Subtitles can be displayed at the bottom of the video playback interface (as an example, the specific subtitles are not displayed in FIG. 2A and FIG. 2B, but are indicated by multiple subtitle words for example).

In FIG. 2A, the video playback interface can display the prompt information of the first display state 201.

In FIG. 2B, the video playback interface can display the prompt information of the second display state 202.

By comparing the prompt information of the first display state 201 with the prompt information of the second display state 202, it can be seen that the font size of the characters in the prompt information of the second display state 202 is smaller than that of the characters in the prompt information of the first display state 201. The display area occupied by the prompt information of the second display state 202 of the video interface is smaller than that occupied by the prompt information of the first display state 201. The occlusion of the video screen or subtitles is reduced.

In some embodiments, the prompt information of the second display state can be transformed to the prompt information of the first display state in response to the user's amplification operation.

It should be noted that after the prompt information of the first display state has been displayed for a period of time, the user can already know the content prompted by the prompt, and the user's demand for the content is reduced when the user has been informed of the content. Even if the user forgets the prompt information a little later, the user can also recall the content by consciously looking at the prompt information. Therefore, by reducing the font size of the characters in the prompt information, the transforming from the first display state to the second display state can be realized in a more prominent way (the first display state of the prompt information) to the user's initial prompt to ensure that the user is fully informed; The less prominent way (the prompt information of the second display state) is used to prevent users from needing to recall the prompt content, thus reducing the occlusion of the prompt information on the video screen.

As an example, the display area of the first display content is larger, and the display area of the second display content is smaller. Transforming the prompt information from the first display content to the second display content can reduce the occlusion of the video screen or subtitles and improve the efficiency of the user to obtain the video content.

In some embodiments, transforming the prompt information from the first display state to the second display state comprises: transforming the prompt information from the first display state to the second display state by using a gradual effect.

As an example, the font size of the characters in the prompt information can be gradually reduced, that is, the gradient effect is adopted to reduce the font size of the characters in the prompt information.

As an example, the way of gradual effect is used to stop displaying the video type prompt information. For example, the video type prompt gets smaller. For example, the video type prompt becomes more transparent.

It should be noted that transforming the first display state to the second display state with a gradual effect can make the user watch the prompt information of the first display state for a longer time, and improve the user's access to the content of the more complete or prominent prompt information.

In some embodiments, on the video playback interface, displaying the prompt information of the first display state comprises: displaying a mask layer on the video playback interface, and displaying the prompt information of the first display state on the mask layer.

Here, the transparency of the mask layer is greater than the preset transparency threshold. It could be understood that the greater the transparency is, the more transparent the mask layer is. As an example, a mask layer can be a transparent mask layer.

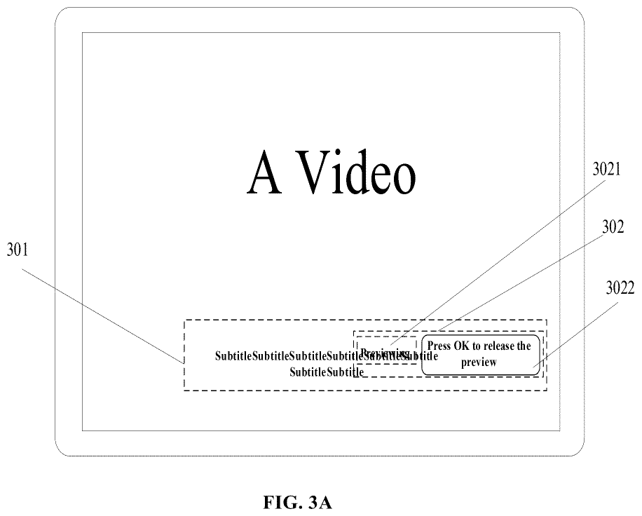

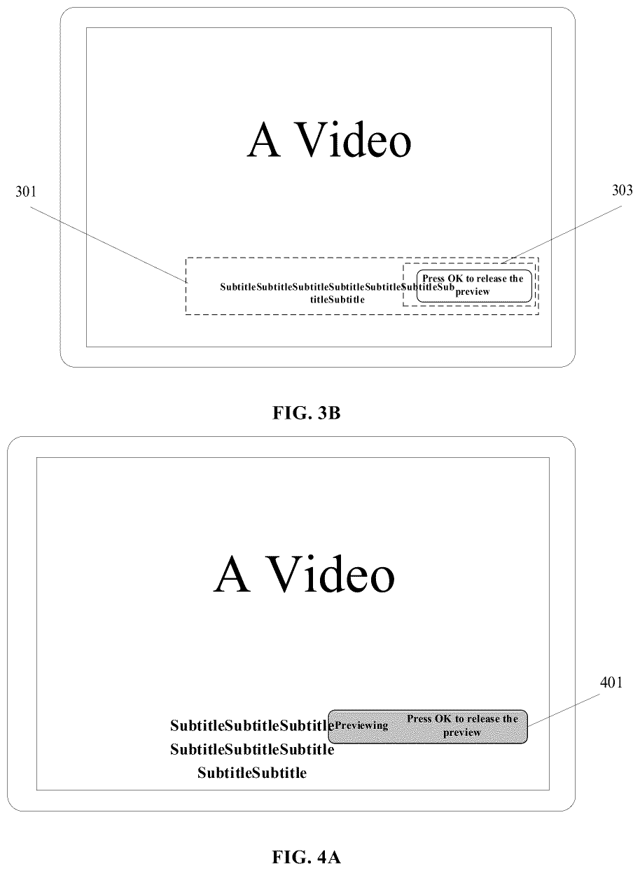

It should be noted that the prompt information is set on the mask layer, which can achieve no occlusion of the video screen or subtitles except for the characters included in the prompt information. Thus, the occlusion of the video screen can be reduced. In addition, even if the characters included in the prompt information partially block the subtitles or video screen, users can still obtain the meaning of subtitles or the content of the screen (as shown in FIG. 3A, even if the characters in the prompt information block part of the subtitles, users can still understand the content of the subtitles).

In some embodiments, displaying the prompt information of the first display state on the video playback interface comprises: displaying a mask layer of a first transparency on the video playback interface, and displaying the prompt information of the first display state on the mask layer of the first transparency.

In some embodiments, in response to the satisfaction of the preset condition, transforming the prompt information from the first display state to the second display state on the video playback interface, comprises: in response to the satisfaction of the preset condition, displaying a mask layer of a second transparency on the video playback interface, and displaying the prompt information of the second display state on mask layer of the second transparency, wherein the second transparency is greater than the first transparency.

As an example, the mask layer on the video playback interface changes from the first transparency to the second transparency, and the second transparency is greater than the first transparency. A mask layer of lower transparency can be used to contrast with the prompt information, allowing users to pay more attention to and learn about the content of the prompt information. Then, when transforming to the prompt information of the second display state, a mask layer of higher transparency can be used to reduce the occlusion of the video screen. Thus, it can not only effectively prompt the user, but also ensure the integrity of the video screen as far as possible.

In some embodiments, the prompt information of the first display state includes video type prompt information and interactive operation prompt information.

In some embodiments, the above step 102 may comprise: stopping the display of the video type prompt on the mask, and retaining the display interaction prompt.

In some embodiments, transforming the prompt information from the first display state to the second display state, comprises: with respect to the video type prompt information displayed on the mask layer, control a color of the video type prompt information to gradually become transparent until the video type prompt information disappears.

As an example, in FIGS. 3A and 3B, the video playback interface can play A Video. Subtitles can be displayed at the bottom of the video playback interface (as an example, the specific subtitles are not shown in FIGS. 3A and 3B, but are indicated by multiple subtitle words for example). The video playback interface can be set to mask 301.

In FIG. 3A, the video playback interface can display the first display state of the mask on the tip 302. The first display state prompt 302 includes the video type prompt 3021 and the interactive operation prompt 3022.

In FIG. 3B, the video playback interface can display the prompt information of the second display state 303 on the mask layer 301. The prompt information of the second display state 303 includes the interactive operation prompt information 3022.

In FIG. 3A and FIG. 3B, by comparing the prompt information of the first display state 302 with the prompt information of the second display state 303, it can be seen that the display area of the video interface occupied by the prompt information of the second display state 303 is smaller than that occupied by the prompt information of the first display state 302. Thus, the occlusion of the video screen or subtitles is reduced.

In some embodiments, displaying prompt information of a first display state on a video playback interface comprises displaying prompt stickers on the video playback interface.

In some embodiments, the prompt stickers comprise a non-transparent background area and a prompt information displayed on the background area.

It should be noted that prominently displaying the prompt information can be achieved by displaying the prompt information in the manner of the prompt sticker. In other words, the non-transparent background area of the prompt sticker can be contrasted with the prompt information, so that users can pay more attention to and know the content of the prompt information.

In some embodiments, the prompt stickers comprise a first sub sticker and a second sub sticker. Here, the first sub sticker is used to display the video type prompt information, and the second sub sticker is used to display the interactive operation prompt information.

In some embodiments, transforming the prompt information from the first display state to the second display state comprises stopping displaying the first sub sticker, and retaining displaying the second sub sticker.

In some embodiments, stopping displaying the first sub sticker may comprise gradually changing the first sub sticker to disappear by means of a gradual effect. For example, gradually increasing the transparency of the first sub sticker until the first sub sticker disappears. For example, the display area of the first sub sticker is gradually reduced until the first sub sticker disappears.

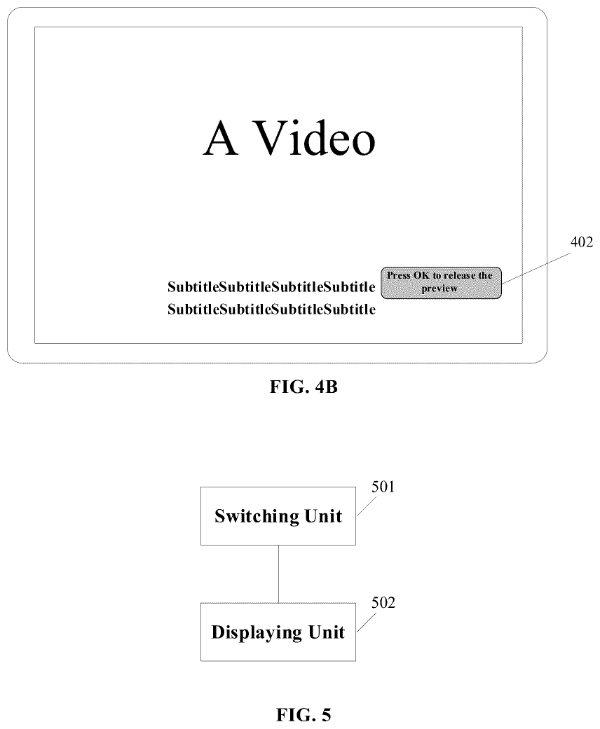

As an example, in FIGS. 4A and 4B, the video playback interface can play A Video. Subtitles can be displayed at the bottom of the video playback interface (as an example, the specific subtitles are not displayed in FIGS. 4A and 4B, but are indicated by multiple subtitle words for example).

In FIG. 4A, the video playback interface can display the prompt information of the first display state 401 on the prompt sticker, which is not transparent. The prompt information of the first display state 401 includes the video type prompt (including the words “Previewing”) and the interactive action prompt (including the words “Press OK to release the preview”).

In FIG. 4B, the video playback interface can display the prompt information of the second display state 402. The prompt information 402 includes the interactive operation prompt information.

In FIG. 4A and FIG. 4B, by comparing the prompt information 401 of the first display state with the prompt information 402 of the second display state, it can be seen that the display area of the video interface occupied by the prompt information of the second display state 402 is smaller than that occupied by the prompt information of the first display state 401. Thus, the occlusion of the video screen or subtitles is reduced.

In some embodiments, wherein the preset condition comprises but is not limited to, at least one of the following: ta duration of displaying the prompt information of the first display state being greater than a first duration threshold; detecting a trigger operation for a zoom control corresponding to the prompt information; and detecting a trigger operation for a deletion control corresponding to the video type prompt information, wherein the video type prompt information is a part of the prompt information.

As an example, the first duration threshold could be 10 seconds.

As an example, a deletion control can be set with respect to the video type prompt information. If the user triggers the deletion control, the prompt information could be transformed from the first display state to the second display state.

It should be noted that the first duration threshold is used as the judgment condition to determine whether to transform, which can provide sufficient reminders to users, but also reduce the occlusion of the video screen or subtitles as much as possible.

It should be noted that the deletion control is set for the prompt information, and/or, the deletion control is set for the video type prompt information, which can meet the needs of users to reduce the display of prompt information in time.

With further reference to FIG. 5, as an implementation of the methods shown in the above figures, the present disclosure provides embodiments of a playback apparatus corresponding to the method embodiment shown in FIG. 1. The device can be specifically applied to various electronic devices.

As shown in FIG. 5, the playback apparatus of the present embodiment comprises: displaying unit 501 and transforming unit 503. The displaying unit is configured to display prompt information of a first display state on a video playback interface in response to a video as a first type of video, wherein the first type of video is provided with a playback restriction, and the prompt information is configured to transform the prompt information from the first display state to a second display state on the video playback interface in response to a satisfaction of a preset condition.

In some embodiments, the specific processing of the displaying unit 501 and the transforming unit 502 of the playback apparatus and the technical effects brought about by them can be referred to the relevant descriptions of steps 101 and 102 respectively in the corresponding embodiments in FIG. 1, and will not be repeated here.

In some embodiments, the method also comprises: displaying a resource transfer interface in response to a trigger operation for the prompt information of the first display state or the prompt information of the second display state; and in response to completing a resource transfer operation through the resource transfer interface, removing the playback restriction to play the video in its entirety.

In some embodiments, the prompt information of the first display state comprises the video type prompt information and the interactive operation prompt information; and transforming the prompt information from the first display state to a second display state comprises: stopping displaying the video type prompt information, and retaining displaying the interactive operation prompt information.

In some embodiments, transforming the prompt information from the first display state to a second display state comprises at least one of the following: moving the prompt information from a first display area to a second display area; scaling the prompt information from a first display style to a second display style; and transforming the prompt information from a first display content to a second display content.

In some embodiments, displaying prompt information of a first display state on a video playback interface comprises: displaying a mask layer of a first transparency on the video playback interface, and displaying the prompt information of the first display state on the mask layer of the first transparency; in response to the satisfaction of the preset condition, transforming the prompt information from the first display state to the second display state on the video playback interface, comprising: in response to the satisfaction of the preset condition, displaying a mask layer of a second transparency on the video playback interface, and displaying the prompt information of the second display state on mask layer of the second transparency, wherein the second transparency is greater than the first transparency.

In some embodiments, the prompt information of the first display state comprises the video type prompt information and the interactive operation prompt information; and transforming the prompt information from the first display state to the second display state, comprises: with respect to the video type prompt information displayed on the mask layer, control a color of the video type prompt information to gradually become transparent until the video type prompt information disappears.

In some embodiments, displaying prompt information of a first display state on a video playback interface comprises: displaying prompt stickers on the video playback interface, wherein the prompt stickers comprises a non-transparent background area and the prompt information displayed on the background area.

In some embodiments, the prompt stickers comprise a first sub sticker and a second sub sticker, wherein the first sub sticker is used to display the video type prompt information, and the second sub sticker is used to display the interactive operation prompt information; and transforming the prompt information from the first display state to a second display state comprises: stopping displaying the first sub sticker, and retaining displaying the second sub sticker.

In some embodiments, the preset condition comprises at least one of the following: a duration of displaying the prompt information of the first display state being greater than a first duration threshold; detecting a trigger operation for a zoom control corresponding to the prompt information; and detecting a trigger operation for a deletion control corresponding to the video type prompt information, wherein the video type prompt information is a part of the prompt information.

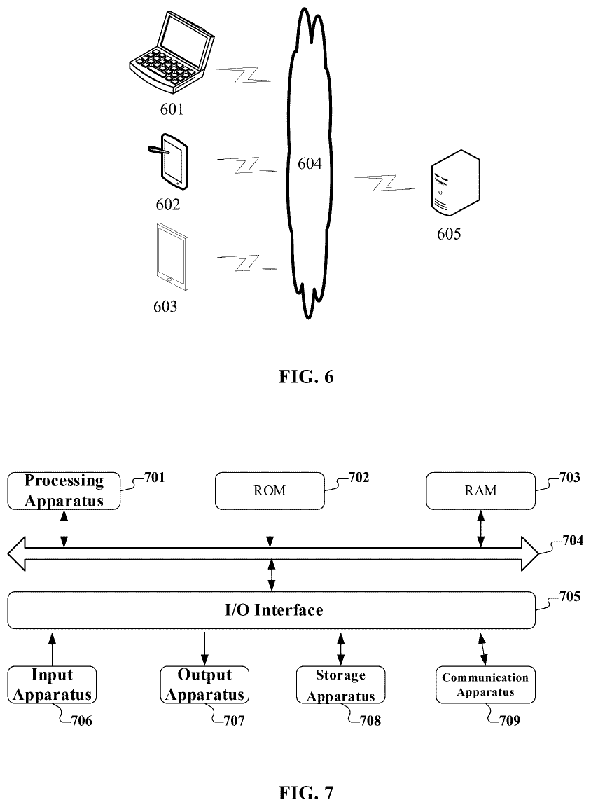

Please refer to FIG. 6, which shows an exemplary system architecture to which the playback method of an embodiment of the present disclosure can be applied.

As shown in FIG. 6, the system architecture can include terminal devices 601, 602, 603, network 604, and server 605. Network 604 is used as a medium to provide a communication link between terminal devices 601, 602, 603 and server 605. Network 604 may include various connection types, such as wired, wireless communication links, or fiber optic cables.

Terminal devices 601, 602, 603 may interact with server 605 through network 604 to receive or send messages, etc. Terminal devices 601, 602, 603 can be installed with various client applications, such as web browser applications, search applications, news and information applications. Client applications in terminal devices 601, 602, 603 can receive user commands and perform corresponding functions according to user commands, such as adding corresponding information to the information according to user commands.

Terminal devices 601, 602, 603 can be hardware or software. When terminal devices 601, 602, 603 are hardware, they can be various electronic devices with display screens and support web browsing, including but not limited to smart phones, tablet computers, e-book readers, MP3 (Moving Picture Experts Group Audio Layer III) players, MP4 (Moving Picture Experts Group Audio Layer IV) players, laptop computer and desktop computer, etc. When the terminal equipment 601, 602, 603 is software, it can be installed in the above listed electronic equipment. It can be implemented into multiple software or software modules (such as software or software modules used to provide distributed services), or it can be implemented into a single software or software module. No specific restrictions are made here.

Server 605 can be a server that provides various services, such as receiving information acquisition requests sent by terminal devices 601, 602, and 603, and obtaining display information corresponding to information acquisition requests through various methods according to information acquisition requests. And the relevant data of the display information is sent to the terminal devices 601, 602, 603.

It should be noted that the playback method provided in the present embodiment may be executed by the terminal equipment, and accordingly the playback apparatus may be set in the terminal devices 601, 602, 603. In addition, the playback method provided by the disclosure embodiment may also be executed by the server 605, and accordingly the playback apparatus may be set in the server 605.

It should be understood that the numbers of terminal devices, networks, and servers shown in FIG. 6 are only indicative. Depending on the implementation, you can have any number of terminals, networks, and servers.

Reference is made below to FIG. 7, which shows a schematic diagram of the construction of an electronic device (e.g., a terminal device or server in FIG. 6) suitable for implementing the present disclosure embodiment. The terminal devices in the present disclosure may include, but are not limited to, mobile terminals such as mobile phones, laptop computers, digital broadcast receivers, PDA (personal digital assistant), PAD (tablet computer), PMP (portable multimedia player), in-vehicle terminals (e.g. in-vehicle navigation terminals), etc., and fixed terminals such as digital TV, desktop computers, etc. The electronic device shown in FIG. 7 is merely an example and should not impose any limitations on the functionality and scope of use of this disclosed embodiment.

As shown in FIG. 7, the electronic device 700 may include a processing apparatus (for example, a central processor, a graphics processor, and the like) 701, which may perform various appropriate actions and processing in accordance with a program stored in a read-only memory (ROM) 702 or a program loaded from a storage apparatus 708 into a random access memory (RAM) 703 to implement the text similarity measurement method according to the embodiments of the present disclosure. The RAM 703 further stores various programs and data required for the operation of the electronic device 700. The processing apparatus 701, the ROM 702, and the RAM 703 are connected to each other through a bus 704. An input/output (I/O) interface 705 is also connected to the bus 704.

Generally, the following apparatus may be connected to the I/O interface 705: an input apparatus 706 including, for example, a touch screen, a touchpad, a keyboard, a mouse, a camera, a microphone, an accelerometer, a gyroscope, and the like; an output apparatus 707 including, for example, a liquid crystal display (LCD), a speaker, a vibrator, and the like; a storage apparatus 708 including, for example, a tape and a hard disk; and a communication apparatus 709. The communication apparatus 709 may allow the electronic device 700 to perform wireless or wired communication with other devices to exchange data. Although FIG. 7 shows the electronic device 700 having various apparatus, it should be understood that it is not required to implement or have all of the shown apparatus. It is possible to implement more or fewer apparatus alternatively.

In particular, according to an embodiment of the present disclosure, the process described above with reference to the flowcharts may be implemented as a computer software program. For example, this embodiment of the present disclosure includes a computer program product, which includes a computer program carried on a non-transitory computer-readable medium, where the computer program includes program code for performing the method shown in the flowchart, so as to implement the text similarity measurement method as described above. In such an embodiment, the computer program may be downloaded from a network through the communication apparatus 709 and installed, installed from the storage apparatus 708, or installed from the ROM 702. When the computer program is executed by the processing apparatus 701, the above-mentioned functions defined in the method of the embodiment of the present disclosure are performed.

It should be noted that the above computer-readable medium described in the present disclosure may be a computer-readable signal medium, or a computer-readable storage medium, or any combination thereof. The computer-readable storage medium may be, for example but not limited to, electric, magnetic, optical, electromagnetic, infrared, or semiconductor systems, apparatuses, or devices, or any combination thereof. A more specific example of the computer-readable storage medium may include, but is not limited to: an electrical connection having one or more wires, a portable computer magnetic disk, a hard disk, a RAM, a ROM, an erasable programmable read-only memory (EPROM or flash memory), an optical fiber, a portable compact disk read-only memory (CD-ROM), an optical storage device, a magnetic storage device, or any suitable combination thereof. In the present disclosure, the computer-readable storage medium may be any tangible medium containing or storing a program that may be used by or in combination with an instruction execution system, apparatus, or device. In the present disclosure, the computer-readable signal medium may include a data signal propagated in a baseband or as a part of a carrier, the data signal carrying computer-readable program code. The propagated data signal may be in various forms, including but not limited to an electromagnetic signal, an optical signal, or any suitable combination thereof. The computer-readable signal medium may also be any computer-readable medium other than the computer-readable storage medium. The computer-readable signal medium can send, propagate, or transmit a program used by or in combination with an instruction execution system, apparatus, or device. The program code contained in the computer-readable medium may be transmitted by any suitable medium, including but not limited to: electric wires, optical cables, radio frequency (RF), and the like, or any suitable combination thereof.

In some implementations, a client and a server may communicate by using any network protocol to be tested and known or to be developed in the future, such as a hypertext transfer protocol (HTTP), and may be connected to digital data communication (for example, a communication network) in any form or medium. Examples of the communication network include a local area network (“LAN”), a wide area network (“WAN”), an internetwork (for example, the Internet), a peer-to-peer network (for example, an ad hoc peer-to-peer network), and any network to be tested and known or to be developed in the future.

The above computer-readable medium may be contained in the above electronic device. Alternatively, the computer-readable medium may exist independently, without being assembled into the electronic device.

The computer readable medium carries one or more programs which, when executed by the electronic device, cause the electronic device to: in response to a video as a first type of video, displaying prompt information of a first display state on a video playback interface, wherein the first type of video is provided with a playback restriction, and the prompt information is used to prompt the removal of the playback restriction; and in response to a satisfaction of a preset condition, transforming the prompt information from the first display state to a second display state on the video playback interface.

In some embodiments, the method further comprising: in response to a trigger operation for the prompt information of the first display state or the prompt information of the second display state, displaying a resource transfer interface; in response to completing a resource transfer operation through the resource transfer interface, removing the playback restriction to play the video in its entirety.

In some embodiments, the prompt information of the first display state comprises video type prompt information and interactive operation prompt information; and transforming the prompt information from the first display state to a second display state comprises: stopping displaying the video type prompt information, and retaining displaying the interactive operation prompt information.

In some embodiments, transforming the prompt information from the first display state to a second display state comprises at least one of the following: moving the prompt information from a first display area to a second display area; scaling the prompt information from a first display style to a second display style; transforming the prompt information from a first display content to a second display content.

In some embodiments, displaying prompt information of a first display state on a video playback interface comprises: displaying a mask layer of a first transparency on the video playback interface, and displaying the prompt information of the first display state on the mask layer of the first transparency; in response to the satisfaction of the preset condition, transforming the prompt information from the first display state to the second display state on the video playback interface, comprising: in response to the satisfaction of the preset condition, displaying a mask layer of a second transparency on the video playback interface, and displaying the prompt information of the second display state on mask layer of the second transparency, wherein the second transparency is greater than the first transparency.

In some embodiments, the prompt information of the first display state comprises the video type prompt information and the interactive operation prompt information; and transforming the prompt information from the first display state to the second display state, comprises: with respect to the video type prompt information displayed on the mask layer, control a color of the video type prompt information to gradually become transparent until the video type prompt information disappears.

In some embodiments, the prompt information of the first display state is displayed on the video playback interface, comprising: displaying the prompt sticker on the video playback interface, wherein the prompt sticker comprises a non-transparent background area and the prompt information displayed on the background area.

In some embodiments, the prompt sticker comprises a first sub sticker and a second sub sticker, wherein the first sub sticker is used to display the video type prompt information, and the second sub sticker is used to display the interactive operation prompt information; and transforming the prompt information from the first display state to the second display state comprises stopping displaying the first sub sticker, and retaining displaying the second sub sticker.

In some embodiments, the preset condition comprises at least one of the following: a duration of displaying the prompt information of the first display state being greater than a first duration threshold; detecting a trigger operation for a zoom control corresponding to the prompt information; and detecting a trigger operation for a deletion control corresponding to the video type prompt information, wherein the video type prompt information is a part of the prompt information.

Computer program code for performing the operations of the disclosure may be written in one or more programming languages, or combinations thereof, including, but not limited to, object-oriented programming languages such as Java, Smalltalk, C++, But also conventional procedural programming languages such as the “C” language or similar programming languages. The program code may be executed entirely on the user's computer, partly on the user's computer, as a stand-alone package, partly on the user's computer and partly on a remote computer, or entirely on a remote computer or server. In the case involving a remote computer, the remote computer may be connected to the user computer over any kind of network, including a local area network (LAN) or a wide area network (WAN), or it may be connected to an external computer (e.g., using an Internet service provider to connect over the Internet).

The flowcharts and block diagrams in the accompanying drawings illustrate the possibly implemented architecture, functions, and operations of the system, method, and computer program product according to various embodiments of the present disclosure. In this regard, each block in the flowchart or block diagram may represent a module, program segment, or part of code, and the module, program segment, or part of code contains one or more executable instructions for implementing the specified logical functions. It should also be noted that, in some alternative implementations, the functions marked in the blocks may also occur in an order different from that marked in the accompanying drawings. For example, two blocks shown in succession may actually be executed substantially in parallel, or they may sometimes be executed in the reverse order, depending on the functions involved. It should also be noted that each block in the block diagram and/or the flowchart, and a combination of the blocks in the block diagram and/or the flowchart may be implemented by a dedicated hardware-based system that executes specified functions or operations, or may be implemented by a combination of dedicated hardware and computer instructions.

The related units described in the embodiments of the present disclosure may be implemented by means of software, or may be implemented by means of hardware. The name of a unit does not constitute a limitation on the unit in some cases.

The functions described herein above may be performed at least partially by one or more hardware logic components. For example, without limitation, exemplary types of hardware logic components that may be used include: a field programmable gate array (FPGA), an application specific integrated circuit (ASIC), an application specific standard product (ASSP), a system on chip (SOC), a complex programmable logic device (CPLD), and the like.

In the context of this disclosure, a machine-readable medium may be a tangible medium that may contain or store a program for use by or in conjunction with an instruction executing system, device, or device. A machine-readable medium may be a machine-readable signaling medium or a machine-readable storage medium. Machine-readable media may include but are not limited to electronic, magnetic, optical, electromagnetic, infrared, or semiconductor systems, devices, or devices, or any suitable combination of the above. More specific examples of machine-readable storage media would include electrical connections based on one or more wires, portable computer disks, hard disks, random access memory (RAM), read-only memory (ROM), erasable programmable read-only memory (EPROM or flash memory), optical fibers, convenient compact disk read-only memory (CD-ROM), optical storage devices, magnetic storage devices, or any suitable combination of the above.

The foregoing descriptions are merely preferred embodiments of the present disclosure and explanations of the applied technical principles. Persons skilled in the art should understand that the scope of disclosure involved in the present disclosure is not limited to the technical solutions formed by specific combinations of the foregoing technical features, and should also cover other technical solutions formed by any combination of the foregoing technical features or their equivalent features without departing from the foregoing concept of disclosure. For example, a technical solution formed by replacing the foregoing features with technical features with similar functions disclosed in the present disclosure (but not limited thereto).

In addition, although various operations are depicted in a specific order, it should be understood as requiring these operations to be performed in the specific order shown or in a sequential order. Under certain circumstances, multitasking and parallel processing may be advantageous. Similarly, although several specific implementation details are included in the foregoing discussions, these details should not be construed as limiting the scope of the present disclosure. Some features described in the context of separate embodiments can also be implemented in combination in a single embodiment. In contrast, various features described in the context of a single embodiment can also be implemented in multiple embodiments individually or in any suitable subcombination.

Although the subject matter has been described in a language specific to structural features and/or logical actions of the method, it should be understood that the subject matter defined in the appended claims is not necessarily limited to the specific features or actions described above. In contrast, the specific features and actions described above are merely exemplary forms of implementing the claims.

1. A playback method, comprising:
in response to a video as a first type of video, displaying prompt information of a first display state on a video playback interface, wherein the first type of video is provided with a playback restriction, and the prompt information is used to prompt the removal of the playback restriction; and
in response to a satisfaction of a preset condition, transforming the prompt information from the first display state to a second display state on the video playback interface.

2. The method according to claim 1, further comprising:
in response to a trigger operation for the prompt information of the first display state or the prompt information of the second display state, displaying a resource transfer interface; and
in response to completing a resource transfer operation through the resource transfer interface, removing the playback restriction to play the video in its entirety.

3. The method according to claim 1, wherein the prompt information of the first display state comprises video type prompt information and interactive operation prompt information; and
transforming the prompt information from the first display state to a second display state comprises:
stopping displaying the video type prompt information, and retaining displaying the interactive operation prompt information.

4. The method according to claim 1, wherein transforming the prompt information from the first display state to a second display state comprises at least one of the following:
moving the prompt information from a first display area to a second display area;
scaling the prompt information from a first display style to a second display style; and
transforming the prompt information from a first display content to a second display content.

5. The method according to claim 1, wherein displaying prompt information of a first display state on a video playback interface comprises:
displaying a mask layer of a first transparency on the video playback interface, and displaying the prompt information of the first display state on the mask layer of the first transparency;
in response to the satisfaction of the preset condition, transforming the prompt information from the first display state to the second display state on the video playback interface, comprising:
in response to the satisfaction of the preset condition, displaying a mask layer of a second transparency on the video playback interface, and displaying the prompt information of the second display state on mask layer of the second transparency, wherein the second transparency is greater than the first transparency.

6. The method according to claim 5, wherein the prompt information of the first display state comprises the video type prompt information and the interactive operation prompt information; and
transforming the prompt information from the first display state to the second display state, comprises:
with respect to the video type prompt information displayed on the mask layer, control a color of the video type prompt information to gradually become transparent until the video type prompt information disappears.

7. The method according to claim 1, wherein displaying prompt information of a first display state on a video playback interface comprises:
displaying prompt stickers comprising a first sub sticker and a second sub sticker on the video playback interface, wherein the first sub sticker is used to display the video type prompt information, and the second sub sticker is used to display the interactive operation prompt information; and
transforming the prompt information from the first display state to a second display state comprises:
stopping displaying the first sub sticker, and retaining displaying the second sub sticker.

8. The method according to claim 1, wherein the preset condition comprises at least one of the following:
a duration of displaying the prompt information of the first display state being greater than a first duration threshold;
detecting a trigger operation for a zoom control corresponding to the prompt information; and
detecting a trigger operation for a deletion control corresponding to the video type prompt information, wherein the video type prompt information is a part of the prompt information.

9. (canceled)

10. An electronic device, comprising:
one or more processors; and
a storage apparatus configured to store one or more programs,
wherein the one or more programs when executed by the one or more processors cause the one or more processors to implement a playback method, comprising:
in response to a video as a first type of video, displaying prompt information of a first display state on a video playback interface, wherein the first type of video is provided with a playback restriction, and the prompt information is used to prompt the removal of the playback restriction; and
in response to a satisfaction of a preset condition, transforming the prompt information from the first display state to a second display state on the video playback interface.

11. A non-transitory computer-readable medium on which a computer program is stored, wherein the computer program when executed by a processor causes the processor to implement a playback method, comprising:
in response to a video as a first type of video, displaying prompt information of a first display state on a video playback interface, wherein the first type of video is provided with a playback restriction, and the prompt information is used to prompt the removal of the playback restriction; and
in response to a satisfaction of a preset condition, transforming the prompt information from the first display state to a second display state on the video playback interface.

12. The electronic device according to claim 10, wherein the method further comprising:
in response to a trigger operation for the prompt information of the first display state or the prompt information of the second display state, displaying a resource transfer interface; and
in response to completing a resource transfer operation through the resource transfer interface, removing the playback restriction to play the video in its entirety.

13. The electronic device according to claim 10, wherein the prompt information of the first display state comprises video type prompt information and interactive operation prompt information; and
transforming the prompt information from the first display state to a second display state comprises:
stopping displaying the video type prompt information, and retaining displaying the interactive operation prompt information.

14. The electronic device according to claim 10, wherein transforming the prompt information from the first display state to a second display state comprises at least one of the following:
moving the prompt information from a first display area to a second display area;
scaling the prompt information from a first display style to a second display style; and
transforming the prompt information from a first display content to a second display content.

15. The electronic device according to claim 10, wherein displaying prompt information of a first display state on a video playback interface comprises:
displaying a mask layer of a first transparency on the video playback interface, and displaying the prompt information of the first display state on the mask layer of the first transparency;
in response to the satisfaction of the preset condition, transforming the prompt information from the first display state to the second display state on the video playback interface, comprising:
in response to the satisfaction of the preset condition, displaying a mask layer of a second transparency on the video playback interface, and displaying the prompt information of the second display state on mask layer of the second transparency, wherein the second transparency is greater than the first transparency.

16. The electronic device according to claim 15, wherein the prompt information of the first display state comprises the video type prompt information and the interactive operation prompt information; and
transforming the prompt information from the first display state to the second display state, comprises:
with respect to the video type prompt information displayed on the mask layer, control a color of the video type prompt information to gradually become transparent until the video type prompt information disappears.

17. The electronic device according to claim 10, wherein displaying prompt information of a first display state on a video playback interface comprises:
displaying prompt stickers comprising a first sub sticker and a second sub sticker on the video playback interface, wherein the first sub sticker is used to display the video type prompt information, and the second sub sticker is used to display the interactive operation prompt information; and
transforming the prompt information from the first display state to a second display state comprises:
stopping displaying the first sub sticker, and retaining displaying the second sub sticker.

18. The electronic device according to claim 10, wherein the preset condition comprises at least one of the following:
a duration of displaying the prompt information of the first display state being greater than a first duration threshold;
detecting a trigger operation for a zoom control corresponding to the prompt information; and
detecting a trigger operation for a deletion control corresponding to the video type prompt information, wherein the video type prompt information is a part of the prompt information.

19. The non-transitory computer-readable medium according to claim 11, wherein the method further comprising:
in response to a trigger operation for the prompt information of the first display state or the prompt information of the second display state, displaying a resource transfer interface; and
in response to completing a resource transfer operation through the resource transfer interface, removing the playback restriction to play the video in its entirety.

20. The non-transitory computer-readable medium according to claim 11, wherein the prompt information of the first display state comprises video type prompt information and interactive operation prompt information; and
transforming the prompt information from the first display state to a second display state comprises:
stopping displaying the video type prompt information, and retaining displaying the interactive operation prompt information.

21. The non-transitory computer-readable medium according to claim 11, wherein transforming the prompt information from the first display state to a second display state comprises at least one of the following:
moving the prompt information from a first display area to a second display area;
scaling the prompt information from a first display style to a second display style; and transforming the prompt information from a first display content to a second display content.
